(19) United States
(12) Patent Application Publication
(10) Pub. No.: US 2011/0185622 A1
(43) Pub. Date: Aug. 4, 2011

(54) FISHING LURE

(76) Inventor: Peter Somogyi, New South Wales (AU)

(21) Appl. No.: 12/997,165

(22) PCT Filed: Jul. 25, 2008
(86) PCT No.: PCT/AU08/01066

§ 371 Date: Apr. 15, 2011

(30) Foreign Application Priority Data
Jun. 11, 2008 (AU) 2008902942

(51) Int. Cl. A01K 85/01; A01K 85/00

(52) U.S. Cl. 43/42.06; 43/42.22; 43/42.33

(57) ABSTRACT

An improved fishing lure (1) including: a head portion (2); a cap member (6); a body portion (13); at least one plug member (302); and at least one attractant and/or weight means whereby the improved fishing lure provides a means for allowing the angler to control the lure's attraction capabilities, adjusting the lure to suit water and weather conditions and also adjusting its swimming action. In another form of the invention there is provided an improved fishing lure including, a body (13), a head portion (2) connected to the body, the head portion having an interior chamber (3) having a first opening and a second opening to allow water to flow from the first opening to the second opening through the interior chamber, the interior chamber being adapted to receive and retain at least one fishing aid while in use.

### FIELD OF THE INVENTION

This invention relates to fishing equipment and accessories, and in particular, to an improved fishing lure which provides a means for allowing the angler to control the lure's attraction capabilities, adjusting the lure to suit water and weather conditions and also adjusting its swimming action.

Whilst the invention may be applied to other similar applications, for convenience sake it shall be described herein in terms of an improved lure device for universal game and sport fishing for catching, attracting and/or teasing predatory fish species.

### BACKGROUND TO THE INVENTION

Any discussion of the prior art throughout the specification should in no way be considered as an admission that such prior art is widely known or forms part of common general knowledge in the field.

The use of lures is quite common for anglers during fishing to attract particular fish species to be caught for sport or game fishing purposes. Traditional methods generally employ the use of live bait. The bait may be thrown or released into the water in a trail form so that the fish will follow the trail, or be otherwise attached to the end of a rigging line.

They have been a number of different lures which have been developed to attract fish to the lure and encourage consumption of the lure. The lure is generally in the form of a fish which the target predatory fish would normally prey upon. The lures are made from numerous materials having different shapes and styles to perform differently in the water. In addition, the colours and styles may also differ to further attract the fish. The major disadvantage with these lures is that they are suited to a particular fish species and/or particular water conditions only which means that a user must carry a number of different lures for their trip.

Accordingly, it is an object of the preferred embodiment of the present invention to overcome or substantially ameliorate the disadvantages of the prior art by providing an improved fishing lure which provides a means for allowing the angler to control the lure's attraction capabilities, adjusting the lure to suit water and weather conditions and also adjusting its swimming action.

### SUMMARY OF THE INVENTION

According to a first aspect of the invention there is provided an improved fishing lure including:

a head portion;
a cap member;
a body portion;
at least one plug member; and
at least one attractant and/or weight means whereby the improved fishing lure provides a means for allowing the angler to control the lure's attraction capabilities, adjusting the lure to suit water and weather conditions and also adjusting its swimming action.

It is preferred that the head portion is substantially cylindrical in shape having a hollow chamber throughout its interior with an opening at the back end.

It is further preferred that provided on the outer surface of the back end of the head portion is preferably at least one thread which is adapted to receive and be engagable with a complimentary threaded portion provided on a cap member to provide a screw connection for the cap member.

It is further preferred that provided on the cap member is preferably at least one hole which is adapted to allow water which has entered the head portion of the lure to flow out as it moves through the water.

It is preferred that the front end of the head portion is preferably adapted to be provided in a plurality of shapes/designs to provide different swimming actions and movement throughout the water for the lure.

It is preferred that provided at the front end of the head portion is preferably at least one hole which is/are adapted to allow water to enter through the fishing lure as it moves though the water.

It is further preferred that a central aperture is preferably provided for rigging the lure to the end of a fishing line.

It is preferred that the plug is preferably made of a rubbery opaque or transparent material which can be easily inserted and removed from the holes at the front end of the lure.

It is preferred that the body portion is in the form of a skirted material which may be varied as required for different lures so that it can be adapted to represent the bait that the lure is trying to imitate.

It is preferred that the attractant may be in the form of at least one scent pellet and/or piece of bait.

It is preferred that the weight means may be in the form of at least one weight pellet.

According to a second aspect of the invention there is provided an improved fishing lure including:

a body;
a head portion connected to the body, the head portion having an interior chamber having a first opening and a second opening to allow water to flow from the first opening to the second opening through the interior chamber, the interior chamber being adapted to receive and retain at least one fishing aid while in use.

Preferable the lure includes a first permeable or grated cap member securably engagable with the second opening for retaining the at least one fishing aid in the interior chamber while allowing water to continue to pass through the second opening.

Preferably the lure includes a second permeable or grated cap member securably engagable with the first opening for allowing water to pass into the chamber.

Preferably also the second cap member has a plurality of holes for allowing water to pass into the chamber and wherein the lure has at least one plug for allowing a user to selectively plug at least one of the holes thereby changing a swimming action of the lure through the water.

Preferably the lure includes a head member selectively attachable to the head portion for changing a shape of the lure and thereby changing the swimming action of the lure through the water.

Preferably the lure includes a tail portion attached to the body for imitating a bait animal.

Preferably the fishing aids include at least of weighted pellets, bait, scent pellets, sounds pellets, vibration pellets or the like.

Preferably each of the first and second cap members includes a central hole for rigging the lure.

### BRIEF DESCRIPTION OF THE DRAWINGS

Preferred embodiments of the invention will now be described, by way of example only, with reference to the accompanying drawings, in which:

FIG. 1 is a side view of a lure according to the invention;

FIG. 2a is a side view of lures having different shaped heads according to the invention;

FIG. 2b is a tope view of hole configurations for the lure of FIG. 1;

FIG. 3a is a side view of a lure with a plug according to the invention;

FIG. 3b is a side view of a lure with a scent pellet according to the invention;

FIG. 3c is a side view of a lure with bait according to the invention;

FIG. 3d is a side view of a lure with weight pellets according to the invention; and

FIG. 3e is a side view of a lure according to the invention.

### DESCRIPTION OF A PREFERRED EMBODIMENT OF THE INVENTION

In order that the invention may be more readily understood we will describe by way of non-limiting example specific embodiments thereof.

In this preferred embodiment, the invention provides an improved fishing lure which provides a means for allowing the angler to control the lure's attraction capabilities, adjusting the lure to suit water and weather conditions and also adjusting its swimming action. The invention shall be described herein in terms of an improved lure device for universal game and sport fishing for catching, attracting and/or teasing predatory fish species. However, it is envisaged that the lure may be modified to be applicable to other similar applications. The lure can preferably be made of different materials such as hard resins, plastics, rubberized soft plastics, metals or any other suitable material depending on the angler's preference and needs. It is envisaged that the shape, style, dimensions and/or features of the lure and/or its components may be varied as desired to suit different fish species, fishing conditions and/or other applications.

The improved fishing lure preferably has provided a head portion. The head portion is substantially cylindrical in shape having a hollow chamber throughout its interior. The opening to the hollow chamber is preferably provided at the back end of the head portion of the fishing lure. The back end of the head portion is preferably recessed so that a cap member can be received thereover. Provided on the outer surface of the back end of the head portion is preferably at least one thread which is adapted to receive and be engagable with a complimentary threaded portion/thread provided on a cap member to provide a screw connection for the cap member. The cap member is adapted to be received over the recessed portion to be connected to the back end of the head portion and secured thereto via a twisting motion to screw the cap member onto the back end of the head portion. Provided on the cap member is preferably at least one hole which is adapted to allow water which has entered the head portion of the lure to flow out as it moves through the water. The holes are preferably circular in shape. However, it is envisaged that any other suitable shape and/or dimensions for the hole(s) may be utilised.

The front end of the head portion is preferably adapted to be provided in a plurality of shapes/designs to provide different swimming actions and movement throughout the water for the lure. Accordingly, the different shaped lures will better suit and be used for particular water conditions due to the manner in which the lure is able to move through the water. Provided at the front end of the head portion is preferably at least one hole. The holes are preferably circular in shape. However, it is envisaged that any other suitable shape and/or dimensions for the hole(s) may be utilised. The hole(s) is/are adapted to allow water to enter through the fishing lure as it moves though the water. Accordingly, the size and number of the holes may be varied to increase/decrease the ease of water flow as required in passive/rough waters. A central aperture is preferably provided for rigging the lure to the end of a fishing line. The central aperture is preferably smaller in diameter than the surrounding holes with suitable dimensions required for rigging.

In an alternate embodiment of the invention, the front end of the head may be adapted to receive a head member thereon. The head member may provide a different shaped head which can be snapped-on or added to the front of the lure to change the swimming action of the lure. The possible head member arrangements may include, but not be limited to, the following:
Snap-on concave head—this will cause the lure to pull near the surface with a long bubble trail.
Slanted head—this will make the lure dive and then swim to the surface as it is pulled along.
Cone-shaped head—the will allow the lure to swim smoothly and dig into the waves and water chop.

The head members will preferably have provided at least one hole which is adapted to align with the hole(s) provided on the front end of the head portion of the lure so that the water is still able to pass through the fishing lure. The head member is preferably provided as an optional attachment to anglers as some may prefer to use the fixed head shape of the fishing lure.

The fishing lure may preferably have provided at least one plug member. The plug member may preferably be in the form of a circular plug which is adapted to be received within a hole provided at the front end of the head portion of the lure. The plug is preferably made of a rubbery opaque or transparent material which can be easily inserted and removed from the holes at the front end of the lure. The plug may have a gripping member or portion which is designed to assist insertion and removal of the plug from the hole. Use of the plug(s) is designed to increase or decrease the water intake by the lure and alter the swimming action of the lure. This can be particularly useful where the weather or water conditions suddenly change. Possible examples for placement of the plugs are provided below.
Plugging opposing side holes in a symmetrical arrangement—make the lure swim more aggressively with a thrashing action at the surface.
Plugging one or more holes on one side only—makes the lure swim erratically like a wounded bait fish.
Plugging one or more of the upper holes—makes the lure swim more aggressively and slightly erratically.

Provided at the back of the lure, forming the body of the lure, is preferably a skirted material. The style of the skirted material may be varied as required for different lures so that it can be adapted to represent the bait that the lure is trying to imitate. The body portion can preferably be made of mylar, tinsel, plastic or any other suitable material. It is envisaged that the shape, colour and style of the body portion may be varied as desired.

The fishing lure preferably has provided at least one scent pellet. The scent pellet is preferably adapted to be placed within the lure to give the lure extra attractant capabilities being able to imitate the scent of the bait it may be designed to represent or an alternate scent suitable for enticing one or more fish species being sought after. It is envisaged that common scents for the pellets may include, but not be limited to, mackerel, pilchard, squid, ballyhoo/garfish, tuna, scad/yellowtail or the like. The pellet(s) is/are preferably inserted into the lure by removing the cap member of the lure and inserting the pellets into the hollow chamber of the lure. As the lure is dragged through the water, the water entering into the lure and chamber will pass over the pellets and release the scent through the holes provided in the cap member at the back of the head portion/chamber. It is envisaged that some pellets may have provided a small slit so that the pellet can be fitted over the rigging line which runs through the centre of the lure.

In a preferred embodiment, at least one piece of bait may also be added to the fishing lure to increase the smell and scent of the bait being released by the lure. The bait is preferably provided in small pieces which can be inserted into the lure by removing the cap member and placing the bait inside the hollow chamber of the lure. The bait works in a similar manner to the pellets whereby the scent is released through the holes provided in the cap member as the lure is dragged through the water and the water rushes across the bait.

The fishing lure preferably has provided at least one weight pellet. The weight pellet(s) is/are preferably inserted into the lure by removing the cap member of the lure and inserting the pellets into the hollow chamber of the lure. The pellets are preferably made of a lead material with a rubberised material on the outside to avoid damage to the lure and other contents of the lure as it moves around inside the lure while being dragged around. The dimensions of the pellet will preferably depend on the desired weight for the pellet and may be provided in a number of different weight increments for selection by an angler on any given day to suit different conditions. The weight pellets act to make the lure heavier to suit different water/weather conditions. Possible examples of use of the weight pellets are provided below.
Calm day with minimal sea chop and swell—no weights need to be added and the lure will swim with a smooth motion. However, the addition of one or more weight pellet(s) will allow the lure to dig into the water more.
Moderate day with medium sea chop and swell—no weights will results in the lure acting erratically and skipping across the surface of the water. Weight pellets can be added to the lure to make the lure heavier so that it will cut through the chop and swell to maximise the swimming action in these conditions and avoid skipping the surface of the water.
Rough conditions—the addition of weight pellets will generally be desirable in these conditions to make the lure heavier so that it can maximise its swimming actions and cut through the chop and swell in the water.

It is envisaged that the weight pellet may have provided a slit to accommodate the rigging fine within the interior of the lure.

In a further embodiment of the invention, at least one sound pellet may be provided which is adapted to attract the fish to the sound generated by the pellet such as a rattle or other suitable noise which can travel long distances under the water. The sound pellet is preferably in the form of a hollow pellet that contains at least two ball bearings which can knock against each other within the pellet to emit sound and vibrations while the lure is in motion. It is envisaged that that ball bearings may be substituted with any other suitable noisy objects can cause a rattling or another noise. As with the other features of the invention, the sound pellet may be combined with one or more of the other features/pellets previously described.

In yet another further embodiment, the invention may preferably have electronic pellets adapted to attract fish using one or more of the combinations below:
Electronic sounds which may be continual or pulsing
Light which is adapted to shine through the holes at the front or rear of the lure depending on the positioning of the pellet as the lure moves through the water
Vibration which is adapted to give the impression to a larger predatory fish that the lure is a wounded baitfish.

The electronic pellets are preferably in the form of a hollow pellet which is adapted to store the electronic components therein. The pellet is preferably designed to have a watertight seal to protect the electronic components inside. The electronic pellet has provided a power source such as a battery and/or other kinetic energy means which can continually charge while the lure is in motion. Activation of the electronic pellet may preferably be via a switch which can be turned on prior to insertion of the electronic pellet into the fishing lure. Alternatively, it is envisaged that activation of the electronic pellet may occur automatically upon submersion into the water. As with the other features of the invention, the electronic pellet may be combined with one or more of the other features/pellets previously described.

In practice, it is envisaged that the scent pellet, bait and weight pellets can be excluded, chosen for use individually and/or used in a combination of more than one product to provide the lure with a means for better handling rougher water conditions and having different scents to provide an attractant for the fish which may be strengthened by employing the use of both the scent pellets and bait. Using the weight pellets in conjunction with the bait will result in the weight pellet pushing against the softer bait at the back end of the chamber so the little pieces of bait will be forced against the holes of the cap member at the back end of the head portion of the lure and little pieces will fall out as the lure is dragged through the water to create a bait trail for a further attractant effect. In the event that these additions are excluded, and there is nothing within the chamber of the lure, the lure will create a very large bubble trail due to the holes at the front and back of the lure.

The lure eliminates the need for having several single purpose lures by replacing them with single one lure that can be adjusted to:
suit water and weather conditions on any given day by having the ability to add and remove weights inside the lure;
have additional attractant capabilities by being able to place scent pellets inside the lures. The scent is released from the back of lure while the lure being dragged through the water;
have additional attractant capabilities by being able to place bait inside the lure which makes the lure smell like that bait;
change the swimming action of the lure by having the ability of plugging some off or all of the holes in the front the lure which makes the lure swim more aggressively or less aggressively or more erratically depending on where and how many plugs are placed in the front of lure, this also changes the range of the bubble trail the lure leaves;
change the swimming action by rigging the lure in one of the outer holes (not center hole). This offsets the point the lure is being dragged from and gives the lure an erratic action like a wounded bait fish; and
have any combinations of the methods described above.

A further embodiment of the invention will now be described with reference to Figures.

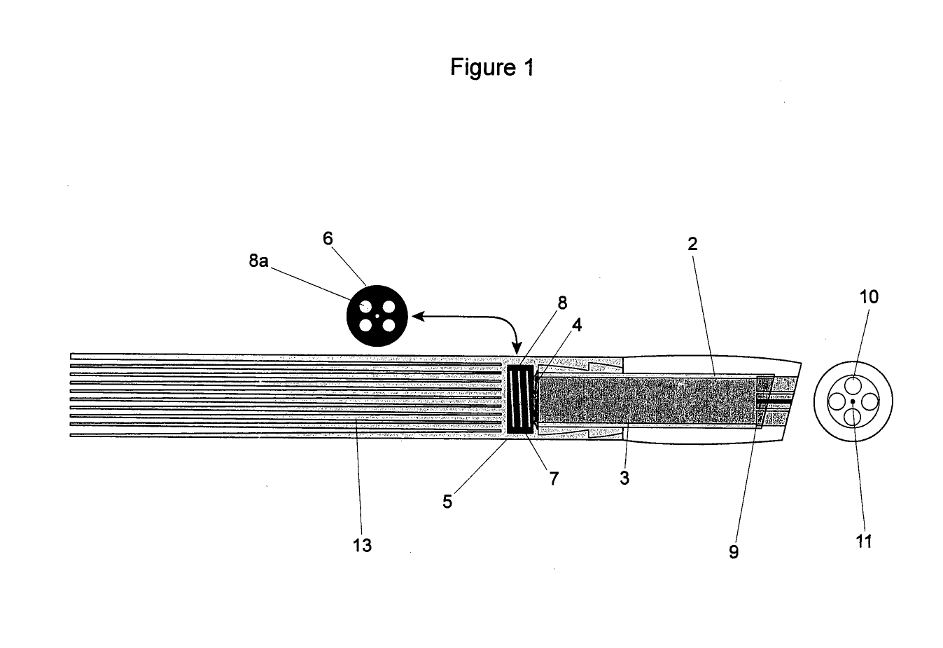

Referring to FIG. 1 there is shown an improved fishing lure 1 having a head portion 2 adapted to receive water. The head portion 2 is substantially cylindrical in shape having a hollow chamber 3 throughout its interior. An opening 4 to the hollow chamber is provided at the back end 5 of the head portion 2 of the fishing lure 1. The back end of the head portion is recessed so that a cap member 6 can be received thereover. Provided on the outer surface of the back end of the head portion is at least one thread 7 which is adapted to receive and be engagable with a complimentary threaded portion/thread provided on the cap member 6 to provide a screw connection for the cap member. The cap member is adapted to be received over the recessed portion 8 to be connected to the back end 5 of the head portion 2 and secured thereto via a twisting motion to screw the cap member 6 onto the back end of the head portion. Provided on the cap member is a plurality of holes 8a which are adapted to allow water which has entered the head portion of the lure to flow out as it moves through the water. The holes are circular in shape, however any other suitable shape (such as square, rectangular, oval, triangular, star shaped) and/or dimensions for the hole(s) may be utilised.

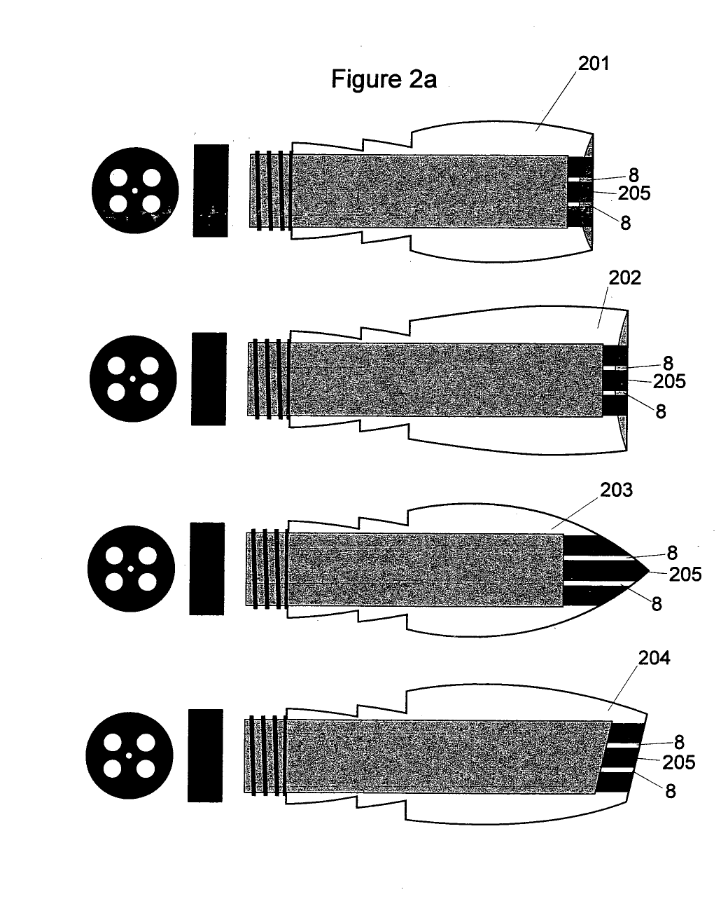

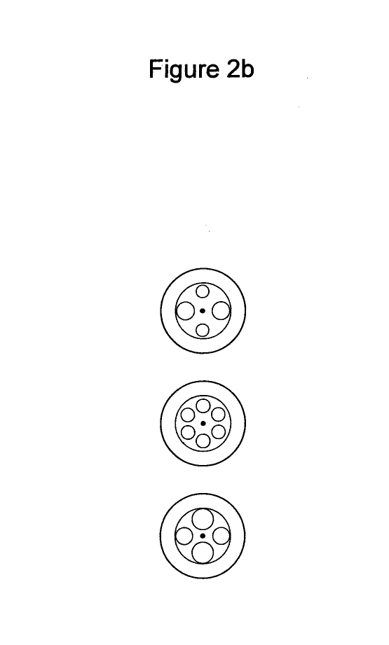

The front end 9 of the head portion 2 is adapted to be provided in a plurality of shapes/designs to provide different swimming actions and movement throughout the water for the lure. Accordingly, the different shaped lures will better suit and be used for particular water conditions due to the manner in which the lure is able to move through the water. Provided at the front end of the head portion is a plurality of holes. The holes are circular in shape. However, it is envisaged that any other suitable shape (such as square, rectangular, oval, triangular, star shaped) and/or dimensions for the hole(s) may be utilised. FIG. 2b shows some examples of possible hole configurations 8. FIG. 2a shows a number of different shaped heads 201, 202, 203, 204 having different lengths and physical characteristics.

The holes 8 are adapted to allow water to enter through the fishing lure as it moves though the water. Accordingly, the size and number of the holes may be varied to increase/decrease the ease of water flow as required in passive/rough waters. A central aperture 11 is preferably provided for rigging the lure to the end of a fishing line. The central aperture is preferably smaller in diameter than the surrounding holes with suitable dimensions required for rigging.

Provided at the back of the lure, forming the body of the lure, is preferably a skirted material 13. The style of the skirted material may be varied as required for different lures so that it can be adapted to represent the bait that the lure is trying to imitate. The body portion can preferably be made of mylar, tinsel, plastic or any other suitable material. It is envisaged that the shape, colour and style of the body portion may be varied as desired.

In another preferred embodiment the front end 9 of the head 2 is adapted to receive a head member 12 thereon. The head member may provide a different shaped head which can be snapped-on or added to the front of the lure to change the swimming action of the lure. The possible head member arrangements may include, but not be limited to, the following:
Snap-on concave head—this will cause the lure to pull near the surface with a long bubble trail.
Slanted head—this will make the lure dive and then swim to the surface as it is pulled along.
Cone-shaped head—the will allow the lure to swim smoothly and dig into the waves and water chop.

Each of the head members has at least one hole 205 which is adapted to align with the hole(s) 8 provided on the front end of the head portion of the lure so that the water is still able to pass through the fishing lure. The head member is preferably provided as an optional attachment to anglers as some may prefer to use the fixed head shape of the fishing lure.

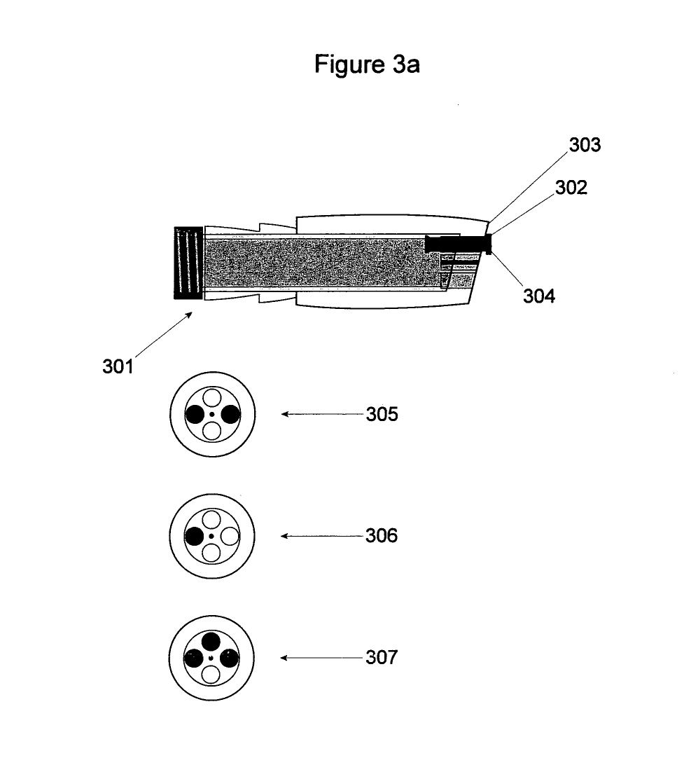

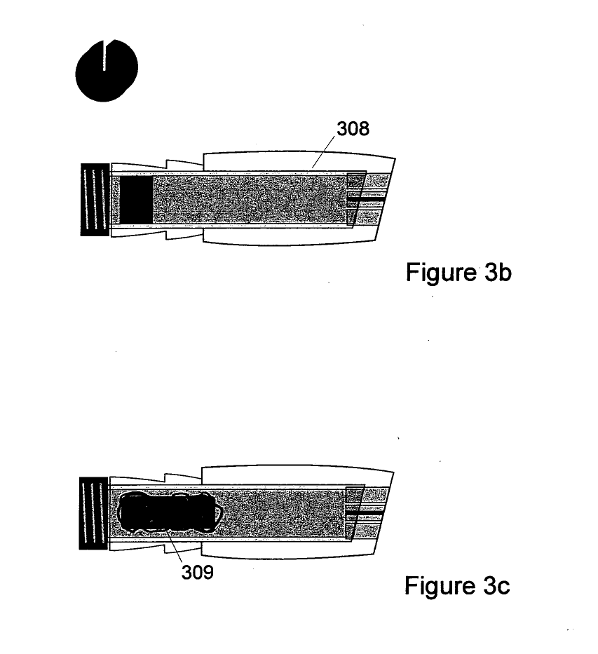

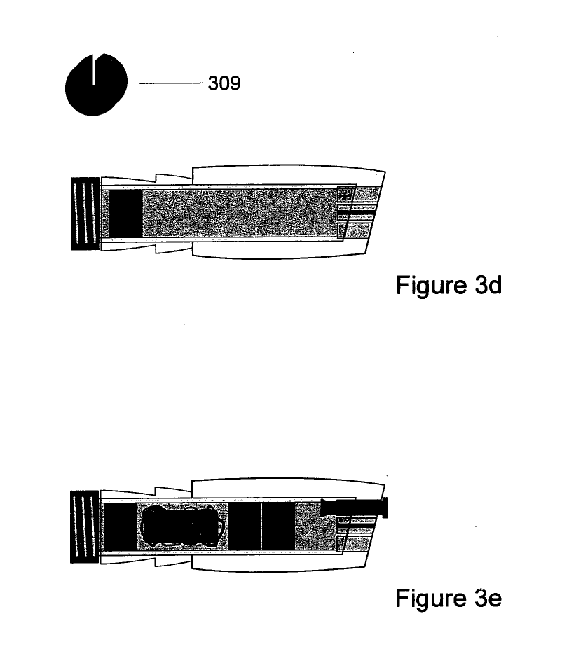

Referring now to FIG. 3, the fishing lure 301a plug member in the form of a circular plug 302 which is adapted to be received within a hole provided at the front end 303 of the head portion of the lure. The plug 302 is preferably made of a rubbery opaque or transparent material which can be easily inserted and removed from the holes at the front end of the lure. The plug may has a gripping member 304 or portion which is designed to assist insertion and removal of the plug from the hole. Use of the plug(s) is designed to increase or decrease the water intake by the lure and alter the swimming action of the lure. This can be particularly useful where the weather or water conditions suddenly change. Possible examples for placement of the plugs are provided below.
Plugging opposing side holes in a symmetrical arrangement as shown in arrangement 305—makes the lure swim more aggressively with a thrashing action at the surface.
Plugging one or more holes on one side only as shown in arrangement 306—makes the lure swim erratically like a wounded bait fish.
Plugging one or more of the upper holes as shown in arrangement 307—makes the lure swim more aggressively and slightly erratically.

Referring to FIG. 3b the fishing lure can receive a scent pellet 308. The scent pellet is preferably adapted to be placed within the lure to give the lure extra attractant capabilities being able to imitate the scent of the bait it may be designed to represent or an alternate scent suitable for enticing one or more fish species being sought after. Common scents for the pellets include, but are not be limited to, mackerel, pilchard, squid, ballyhoo/garfish, tuna, scad/yellowtail or the like. The pellet(s) is/are preferably inserted into the lure by removing the cap member of the lure and inserting the pellets into the hollow chamber of the lure. As the lure is dragged through the water, the water entering into the lure and chamber will pass over the pellets and release the scent through the holes provided in the cap member at the back of the head portion/chamber. It is envisaged that some pellets may have provided a small slit so that the pellet can be fitted over the rigging line which runs through the centre of the lure.

As shown in FIG. 3c at least one piece of bait may also be added to the fishing lure to increase the smell and scent of the bait being released by the lure. The bait is preferably provided in small pieces which can be inserted into the lure by removing the cap member and placing the bait inside the hollow chamber of the lure. The bait works in a similar manner to the pellets whereby the scent is released through the holes provided in the cap member as the lure is dragged through the water and the water rushes across the bait.

Referring now to FIG. 3d the fishing lure has provided at least one weight pellet 309. The weight pellet(s) is/are preferably inserted into the lure by removing the cap member of the lure and inserting the pellets into the hollow chamber of the lure. The pellets are preferably made of a lead material with a rubberised material on the outside to avoid damage to the lure and other contents of the lure as it moves around inside the lure while being dragged around. The dimensions of the pellet will preferably depend on the desired weight for the pellet and may be provided in a number of different weight increments for selection by an angler on any given day to suit different conditions. The weight pellets act to make the lure heavier to suit different water/weather conditions. Possible examples of use of the weight pellets are provided below.
Calm day with minimal sea chop and swell—no weights need to be added and the lure will swim with a smooth motion. However, the addition of one or more weight pellet(s) will allow the lure to dig into the water more.
Moderate day with medium sea chop and swell—no weights will results in the lure acting erratically and skipping across the surface of the water. Weight pellets can be added to the lure to make the lure heavier so that it will cut through the chop and swell to maximise the swimming action in these conditions and avoid skipping the surface of the water.
Rough conditions—the addition of weight pellets will generally be desirable in these conditions to make the lure heavier so that it can maximise its swimming actions and cut through the chop and swell in the water.

The weight pellet has a slit to accommodate the rigging line within the interior of the lure. The weight pellets can be similar in shape to the scent pellets. Typically the depth of the weight pellets vary to that of the scent pellets. Multiple of single weight pellets can be added to adapt the lure to ocean/water conditions. Weight pellets can also be used in conjunction with scent pellets, bait and plugs in any combination as shown in FIG. 3e. The lure shown in FIG. 3e has a bait pellet and scent pellet inside so that is smells like actual bail. It also has two weights to help it swim through rougher water more effectively and a plug in the front to make it swim more aggressively and erratically.

In use, a user prepares the lure by threading the desired combination of bait, pellets (scent and otherwise) and weights through the rigging line. The desired head member is also chosen and attached to the body with the rigging line running there through. The rigging line in then passed through the centre hole 205 in the head portion and the centre hole in the back portion 7. The combination of bait, pellets and weights sit inside the chamber 3 as shown in FIG. 3e. If desired, a user inserts plugs 302 into one or more of the holes 8. Once the lure is ready for casting, the line is cast. The lure can then be reeled in and the configuration altered as required.

While we have described herein a particular embodiment of an improved fishing lure, it is further envisaged that other embodiments of the invention could exhibit any number and combination of any one of the features previously described. However, it is to be understood that any variations and modifications can be made without departing from the spirit and scope thereof.

1. An improved fishing lure comprising:
a head portion;
a cap member;
a body portion;
at least one plug member; and
at least one attractant angler weight means wherein the improved fishing lure provides a means to control the lure's attraction capabilities, adjusting the lure to suit water and weather conditions and adjust its swimming action.

2. An improved fishing lure as claimed in claim 1 wherein the head portion is substantially cylindrical in shape having a hollow chamber throughout its interior with an opening at the back end.

3. An improved fishing lure as claimed in claim 2 wherein there is provided on the outer surface of the back end of the head portion at least one thread which is adapted to receive and be engagable with a complimentary threaded portion provided on the cap member to provide a screw connection for the cap member.

4. An improved fishing lure as claimed in claim 3 wherein provided on the cap member is at least one hole which is adapted to allow water which has entered the head portion of the lure to flow out as it moves through the water.

5. An improved fishing lure as claimed in claim 4 wherein the front end of the head portion is preferably adapted to be provided in a plurality of shapes to provide different swimming actions and movement throughout the water for the lure.

6. An improved fishing lure as claimed in claim 5 wherein at the front end of the head portion is at least one hole which is adapted to allow water to enter through the fishing lure as it moves though the water.

7. An improved fishing lure as claimed in claim 6 wherein a central aperture is provided for rigging the lure to the end of a fishing line.

8. An improved fishing lure as claimed in claim 1 wherein the plug is made of a rubbery opaque or transparent material which can be easily inserted and removed from the holes at the front end of the lure.

9. An improved fishing lure as claimed in claim 1 wherein the body portion is in the form of a skirted material which may be varied as required for different lures so that it can be adapted to represent the bait that the lure is trying to imitate.

10. An improved fishing lure as claimed in claim 1 wherein the attractant is selected from the group consisting of at least one scent pellet and at least one piece of bait.

11. An improved fishing lure as claimed in claim 1 wherein the weight means may be in the form of at least one weight pellet.

12. An improved fishing lure comprising:
a body;
a head portion connected to the body, the head portion having an interior chamber having a first opening and a second opening to allow water to flow from the first opening to the second opening through the interior chamber, the interior chamber being adapted to receive and retain at least one fishing aid while in use.

13. An improved fishing lure according to claim 12 further comprising a first permeable or grated cap member securably engagable with the second opening for retaining the at least one fishing aid in the interior chamber while allowing water to continue to pass through the second opening.

14. An improved fishing lure according to claim 13 further comprising a second permeable or grated cap member securably engagable with the first opening for allowing water to pass into the chamber.

15. An improved fishing lure according to claim 14 wherein the second cap member has a plurality of holes for allowing water to pass into the chamber and wherein the lure has at least one plug for allowing a user to selectively plug at least one of the holes thereby changing a swimming action of the lure through the water.

16. An improved fishing lure according to claim 15 further comprising a head member selectively attachable to the head portion for changing a shape of the lure and thereby changing the swimming action of the lure through the water.

17. An improved fishing lure according to claim 16 further comprising a tail portion attached to the body for imitating a bait animal.

18. An improved fishing lure according to claim 12 wherein the fishing aids include at least of weighted pellets, bait, scent pellets, sounds pellets, vibration pellets or the like.

19. An improved fishing lure according to claim 17 wherein each of the first and second cap members includes a central hole for rigging the lure.
